(19) United States
(12) Patent Application Publication
(10) Pub. No.: US 2026/0023744 A1
(43) Pub. Date: Jan. 22, 2026

(54) JOIN CONSTRAINTS FOR QUERY PROCESSING

(71) Applicant: Snowflake Inc., Bozeman, MT (US)

(72) Inventors: Samuel Cheng, San Francisco, CA (US); Valentin K. Kuznetsov, Bellevue, WA (US); Henry Liu, Cupertino, CA (US); Seyed Hamid Mousavi Behbahani, Mountain View, CA (US); David Schultz, Piedmont, CA (US)

(21) Appl. No.: 18/776,918

(22) Filed: Jul. 18, 2024

(51) Int. Cl. G06F 16/2455

(52) U.S. Cl. CPC G06F 16/2456; G06F 16/24565

(57) ABSTRACT

Described is a system for join constraints for query processing by receiving a first query directed towards a shared dataset in a data clean room; assessing the first query to identify that the one or more functions s at least a join function; determining that the first query is configured to join a first set of data from the shared dataset with a second set of data using the join function; determining that a join constraint policy is to be enforced in relation to the first query; and generating an output to the first query based on the execution of the one or more functions, the output to the first query without data values stored in the portion of the first set of data based on determining that the join constraint policy is to be enforced in relation to the first query.

### TECHNICAL FIELD

Embodiments of the disclosure relate generally to cloud data platforms and, more specifically, to join constraint policies while processing a query.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment in which a network-based database system can implement join constraints, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a flow diagram illustrating an example method for enforcing join constraints for query processing, according to some embodiments.

FIG. 5 is an architectural diagram illustrating join constraint policy enforcement, according to some example embodiments.

FIG. 6 illustrates an architectural diagram illustrating executing of a query template based on a plurality of different constraint types, according to some example embodiments.

FIG. 7 illustrates an example diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

Data clean rooms (DCRs) are secure environments where multiple parties can collaborate on data analysis without directly accessing each other's raw data. These systems are designed to comply with privacy regulations and can include features like query constraints, aggregation policies, and data masking to ensure data privacy and security during collaborative analysis.

Managing query constraints and privacy policies can be cumbersome and unintuitive, often requiring separate definitions and management of policies. Traditional systems may enforce a rigid structure for queries and constraints, limiting flexibility in how data can be queried and shared. Systems relying on templates for query constraints can be overly restrictive, preventing full SQL support and complicating cross-platform data collaboration.

Existing solutions may provide broad sets of query restrictions, which, while enhancing data privacy, can be overly restrictive and not tailored to specific needs. Moreover, traditional DCRs may be vulnerable to certain attack vectors, such as SQL injection attacks, where malicious actors can manipulate query templates to access sensitive data.

Traditional systems may struggle with interoperability across different storage and query processing platforms. This can hinder the ability to perform joins and other data operations on datasets stored on different cloud service providers. When cross-platform queries are enabled, reaching a common agreement on query templates can be challenging, leading to inefficiencies and potential data governance issues.

Certain rules such as join rules, aggregation rules, and differential privacy rules are often managed separately, leading to potential inconsistencies and difficulties in enforcement. Applying rules manually to individual datasets or queries can be error-prone and time-consuming, reducing the efficiency of data governance.

The complexity and overhead associated with managing multiple constraints and policies can degrade system performance. Scaling traditional DCR solutions to handle large volumes of data and numerous concurrent users can be challenging, particularly when policies need to be evaluated in real-time.

The embodiments described herein addresses these issues resulting in a more efficient, flexible, and secure data clean room solution, enhancing data governance and enabling more effective data collaboration.

The data platform integrates join constraint policy into datasets, and can be integrated into an existing policy framework, which already supports various privacy-enhancing technologies (PETs) such as an aggregation policy and projection policy. This unification simplifies the management of policies, as users can define and enforce join constraints using the same familiar interface. Customers can define their own policy body and enforcement logic, which are evaluated at query time. This allows for more intuitive and streamlined workflows compared to traditional systems that require separate definitions for different policies.

Unlike template-based systems, the data platform supports full SQL, providing customers with the flexibility to write any query while the join constraint policy ensures that privacy and data governance requirements are met. This removes the limitations imposed by rigid query templates. The join constraint policy can be highly customized to allow, block, or limit certain types of joins and conjunctions of conditions. This allows for more tailored and precise control over data operations.

By focusing on join constraints, the data platform provides a more precise way to control data usage. Only data that meets the specified join criteria is included in the results, reducing the potential for unintended data exposure. The policy is dynamically enforced at query compilation time, ensuring that the latest policy definitions are applied, thereby enhancing security and reducing susceptibility to attack vectors like SQL injection.

The join constraint policy can be combined with other policies such as differential privacy and aggregation policies. This layered approach enhances overall security by providing multiple levels of data protection.

The join constraint policy is designed to work across different cloud service providers. This interoperability allows for seamless data operations involving datasets stored on various platforms, overcoming the limitations of traditional systems that struggle with cross-platform compatibility. By attaching policies directly to the data (e.g., as columns in the dataset), the policies are enforced regardless of the query's origin, facilitating cross-platform data collaboration. Customers can write any query without the need for predefined templates. This flexibility removes the need for common agreements on query formats across platforms, simplifying cross-platform operations.

The join policy is attached to the data itself. Whenever a query is run against the table, the policy is automatically enforced. This reduces the manual effort required to apply policies and ensures consistent enforcement across all queries. Policies can be defined once and reused across similar tables, enhancing efficiency and reducing the potential for errors in policy application.

Customers can specify allow and deny join keys at the column level, providing fine-grained control over which data can be used in join operations. This helps in protecting sensitive information more effectively.

By integrating join constraints into the policy framework, the data platform can evaluate and enforce policies efficiently at query time. This reduces the performance overhead compared to traditional systems that manage multiple separate constraints. The data platform is designed to scale with the data volume and number of concurrent users, ensuring consistent performance even in large-scale deployments.

Policies are applied in real-time as queries are executed, ensuring that the most current rules are enforced. This enhances both performance and privacy by reducing the lag between policy updates and their enforcement.

By addressing the limitations of traditional systems and incorporating these technological advantages, the data platform offers a more efficient, flexible, and secure approach to data governance and privacy in data clean rooms.

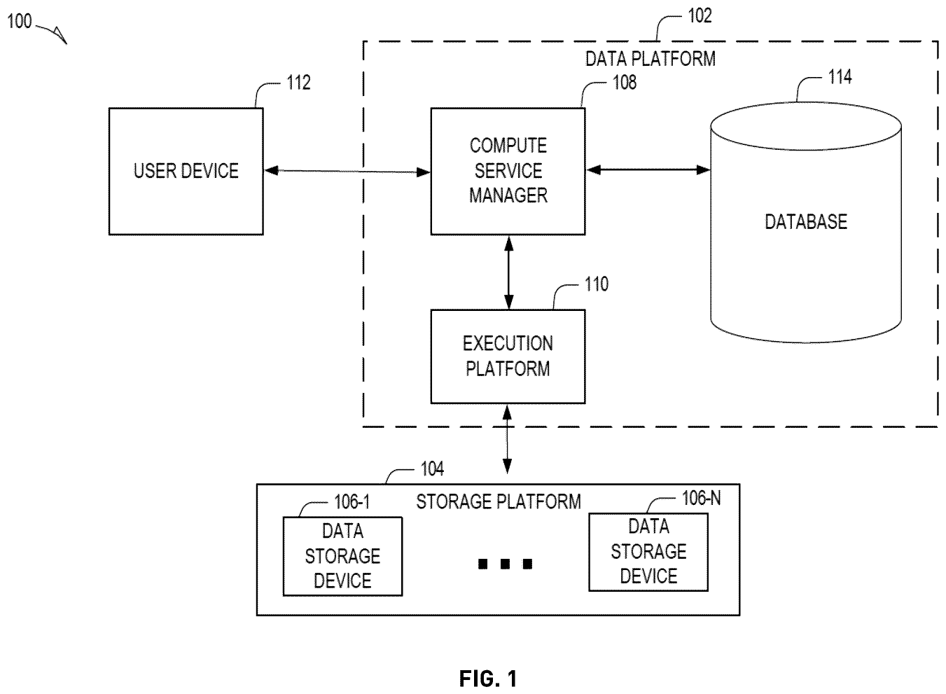

FIG. 1 illustrates an example computing environment 100 that includes a data platform 102 in communication with a storage platform 104, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform.

As shown, the computing environment 100 comprises the data platform 102 and the storage platform 104 (e.g., AWS®, Microsoft Azure Blob Storage®, or Google Cloud Storage®). The data platform 102 is used for reporting and analysis of integrated data from one or more disparate sources including storage devices 106-1 to 106-N within the storage platform 104. The storage platform 104 comprises a plurality of computing machines and provides on-demand computer system resources such as data storage and computing power to the data platform 102.

The data platform 102 comprises a compute service manager 108, an execution platform 110, and a database 114. The data platform 102 hosts and provides data reporting and analysis services to multiple client accounts. Administrative users can create and manage identities (e.g., users, roles, and groups) and use permissions to allow or deny access to the identities to resources and services.

The compute service manager 108 coordinates and manages operations of the data platform 102. The compute service manager 108 also performs query optimization and compilation as well as managing clusters of computing services that provide compute resources (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also in communication with a user device 112. The user device 112 corresponds to a user of one of the multiple client accounts supported by the data platform 102. In some embodiments, the compute service manager 108 does not receive any direct communications from the user device 112 and only receives communications concerning jobs from a queue within the data platform 102.

The compute service manager 108 is also coupled to database 114, which is associated with the data stored in the computing environment 100. The database 114 stores metadata pertaining to various functions and aspects associated with the data platform 102 and its users. In some embodiments, the database 114 includes a summary of data stored in remote data storage systems as well as data available from a local cache. Additionally, the database 114 may include information regarding how data is organized in remote data storage systems (e.g., the storage platform 104) and the local caches. The database 114 allows systems and services to determine whether a piece of data needs to be accessed without loading or accessing the actual data from a storage device.

For example, the database 114 can include metadata that includes information about data stored in the table such as minimum and maximum values stored in particular portions of the table. For example, as noted above, a table may be organized into multiple granular storage units such as micro-partitions. The multiple storage units may be stored (e.g., as files) across multiple blocks (or compression blocks). That is, a block may comprise a set of storage units (e.g., partitions or micro-partitions) and the set of storage units may be a subset of the multiple storage units into which the table is organized. The metadata associated with the table may specify a minimum and maximum value for each storage unit as well as each block. The metadata stored in the database 114 can be used by one or more components of the data platform 102 (e.g., to perform pruning during query processing). In an example, given a query directed at a table organized into storage units (e.g., a set of micro-partitions), one or more components of the data platform 102 can use the metadata to identify a reduced set of storage units to scan in executing the query. The set of storage units to scan in executing a query may be referred to herein as a “scan set.”

The compute service manager 108 is further coupled to the execution platform 110, which provides multiple computing resources that execute various data storage and data retrieval tasks. The execution platform 110 comprises a plurality of compute nodes. A set of processes on a compute node executes at least a portion of a query plan compiled by the compute service manager 108.

The execution platform 110 is coupled to storage platform 104 of the storage platform 104. The storage platform 104 comprises multiple data storage devices 106-1 to 106-N. In some embodiments, the data storage devices 106-1 to 106-N are cloud-based storage devices located in one or more geographic locations. For example, the data storage devices 106-1 to 106-N may be part of a public cloud infrastructure or a private cloud infrastructure. The data storage devices 106-1 to 106-N may be hard disk drives (HDDs), solid state drives (SSDs), storage clusters, Amazon S3™ storage systems or any other data storage technology. Additionally, the storage platform 104 may include distributed file systems (e.g., Hadoop Distributed File Systems (HDFS)), object storage systems, and the like.

The execution platform 110 comprises a plurality of compute nodes. A set of processes on a compute node executes a query plan compiled by the compute service manager 108. The set of processes can include: a first process to execute the query plan; a second process to monitor and delete cache files using a least recently used (LRU) policy and implement an out of memory (OOM) error mitigation process; a third process that extracts health information from process logs and status to send back to the compute service manager 108; a fourth process to establish communication with the compute service manager 108 after a system boot; and a fifth process to handle all communication with a compute cluster for a given job provided by the compute service manager 108 and to communicate information back to the compute service manager 108 and other compute nodes of the execution platform 110.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 1, the data storage devices 106-1 to 106-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 108, database 114, execution platform 110, and storage platform 104 are shown in FIG. 1 as individual discrete components. However, each of the compute service manager 108, database 114, execution platform 110, and storage platform 104 may be implemented as a distributed system (e.g., distributed across multiple systems/platforms at multiple geographic locations). Additionally, each of the compute service manager 108, database 114, execution platform 110, and storage platform 104 can be scaled up or down (independently of one another) depending on changes to the requests received and the changing needs of the data platform 102. Thus, in the described embodiments, the data platform 102 is dynamic and supports regular changes to meet the current data processing needs.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the database 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the computing environment 100 separates the execution platform 110 from the storage platform 104. In this arrangement, the processing resources and cache resources in the execution platform 110 operate independently of the data storage devices 106-1 to 106-N in the storage platform 104. Thus, the computing resources and cache resources are not restricted to specific data storage devices 106-1 to 106-N. Instead, all computing resources and all cache resources may retrieve data from, and store data to, any of the data storage resources in the storage platform 104.

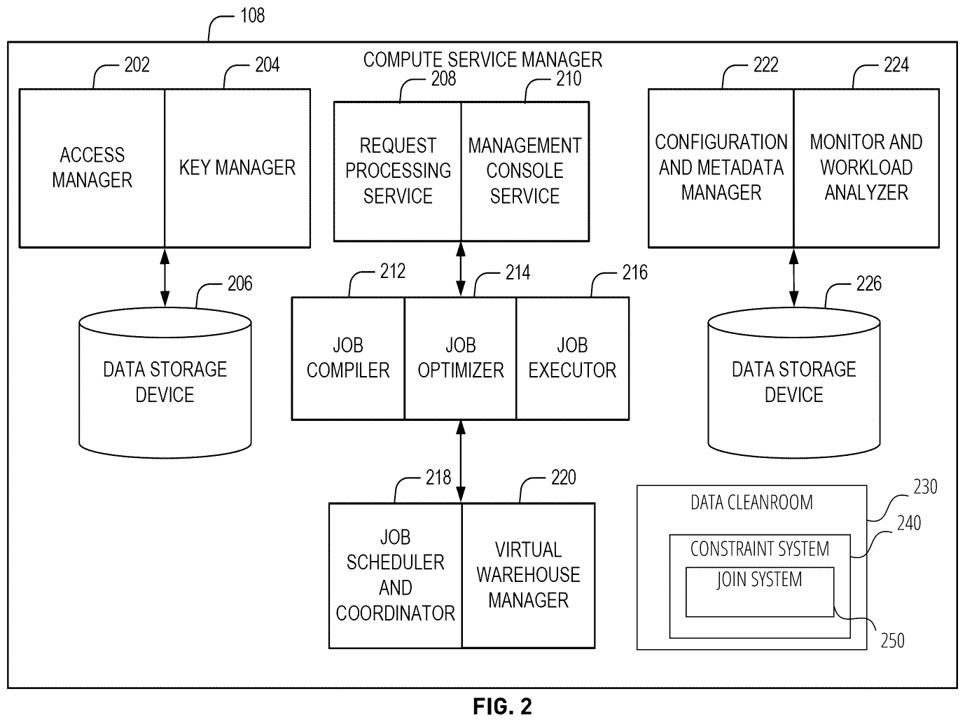

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data storage device 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in storage platform 104). As used herein, the remote storage devices may also be referred to as “persistent storage devices” or “shared storage devices.”

The credential management system 204 facilitates use of remote stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the data storage device 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the data storage device 206 (e.g., access metadata database, a credential object, and a credential store definition) to retrieve security credentials used to access the external resource from a remote credential store.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110, any one of which may be configured (e.g., by the virtual warehouse manager 220) to include any one or more of a table scan operator and a top k operator. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage unites need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in storage platform 104, or any other storage device.

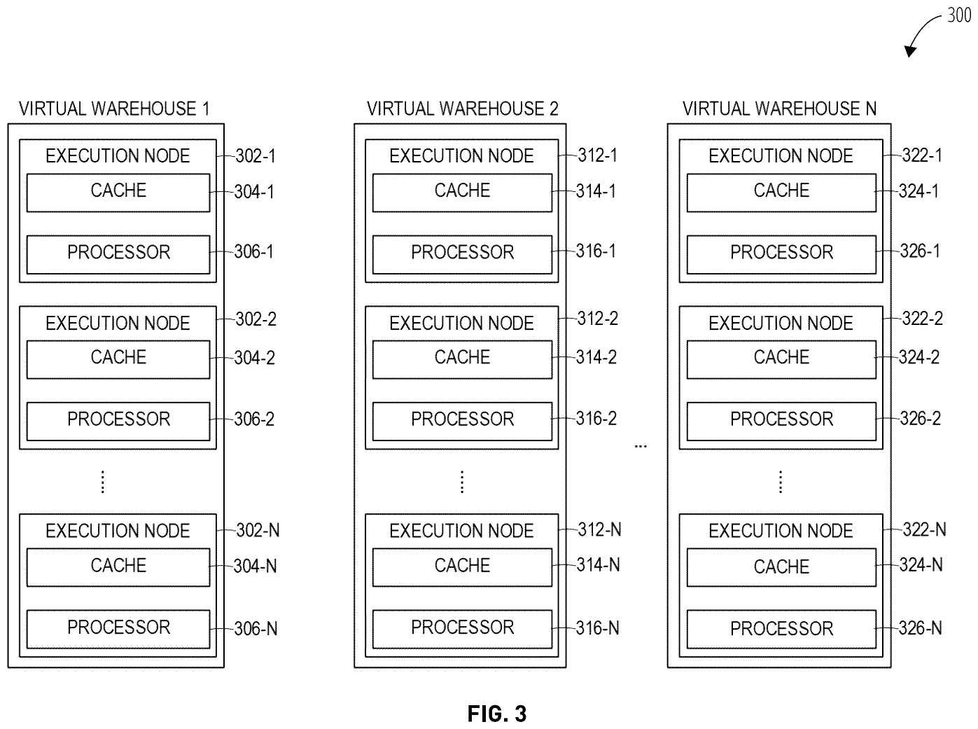

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 302-1 of FIG. 3) may need to communicate with another execution node (e.g., execution node 302-2 of FIG. 3), but should be disallowed from communicating with a third execution node (e.g., execution node 312-1), and any such illicit communication can be recorded (e.g., in a log or other location). Also, the information stored on a given execution node is restricted to data relevant to the current query, and any other data is unusable, rendered so by destruction or encryption where the key is unavailable.

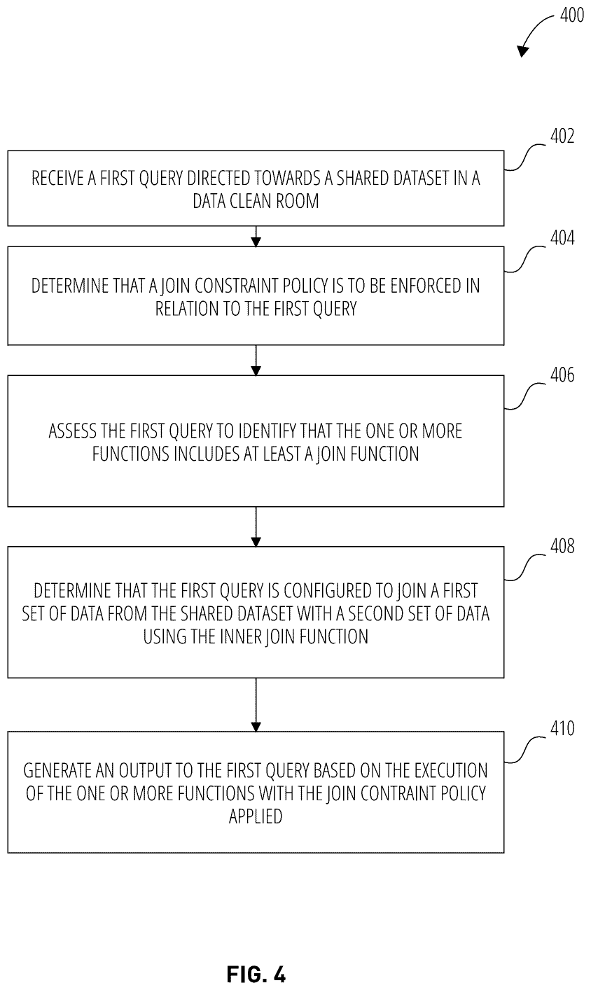

The data clean room system 230 allows for dynamically restricted data access to shared datasets. The constraint system 240 provides for constraints, such as join constraints on data values stored in specified columns of shared datasets or join constraints on join functions. An join system 250 can be implemented within the cloud data platform 102 when processing queries directed to tables in shared datasets. The join system 250 (also referred to as the join constraint system) is described in detail in connection with FIG. 4. For example, in some embodiments, the join system 250 can be implemented within a clean room provided by the data clean room system 230 and/or in conjunction with the constraint system 240.

The constraint system 240 enables entities to establish constraints (e.g., join constraint policies) to shared datasets. A constraint identifies that the data in a column may be restricted from being projected (e.g., presented, read, outputted) in an output to a received query, while allowing specified operations to be performed on the data and a corresponding output to be provided. For example, the join constraint may indicate a context for a query that triggers the constraint, such as based on the user that submitted the query.

For example, the constraint system 240 may provide a user interface or other means of communication that allows entities to define join constraints in relation to their data that is maintained and managed by the cloud data platform 102. To define a join constraint, the constraint system 240 enables users to provide data defining the shared datasets and/or columns to which a join constraint should be associated (e.g., attached). For example, a user may submit data defining a specific column and/or a group of columns within a shared dataset, or an entire table that should be attached with the join constraint.

Further, the constraint system 240 enables users to define conditions for triggering the join constraint. This may include defining the specific context and/or contexts that triggers enforcement of the join constraint. For example, the constraint system 240 may enable users to define roles of users, accounts and/or shares, which would trigger the join constraint and/or are enabled to project the constrained column of data. After receiving data defining a join constraint, the constraint system 240 generates a file that is attached to the identified columns. In some embodiments, the file may include a Boolean function based on the provided conditions for the join constraint. For example, the Boolean function may provide an output of true if the join constraint should be enforced in relation to a query and an output of false if the join constraint should not be enforced in relation to a query. Attaching the file to the column or table establishes the join constraint to the column of data for subsequent queries.

The constraint system 240 receives a query directed to a shared dataset. The query may include data defining data to be accessed and one or more operations to perform on the data. The operations may include any type of operations used in relation to data maintained by the cloud data platform 102, such as join operation, read operation, and the like. The constraint system 240 may provide data associated with the query to the other components of the constraint system 240, such as a data accessing component, a query context determination component, or other components of the constraint system 240. The constraint system 240 accesses a set of data based on a query received by the constraint system 240 or a component thereof. For example, the data accessing component may access data from columns and/or sub-columns of the shared dataset that are identified by the query and/or are needed to generate an output based on the received query. The constraint system 240 may provide the accessed data to other components of the constraint system 240, such as a join constraint enforcement component. The constraint system 240 determines the columns associated with the data accessed by the constraint system 240 in response to a query. This can include columns and/or sub-columns from which the data was accessed. The constraint system 240 may provide data identifying the columns to the other components of the constraint system 240, such as a join constraint determination component.

The constraint system 240 determines whether a join constraint (e.g., join constraint policy) is attached to any of the columns identified by the constraint system 240. For example, the constraint system 240 determines whether a file defining a join constraint is attached to any of the columns and/or sub-columns identified by the constraint system 240. The constraint system 240 may provide data indicating whether a join constraint is attached to any of the columns and/or the file defining the join constraints to the other components of the constraint system 240, such as an enforcement determination component.

The constraint system 240 determines a context associated with a received query. For example, the constraint system 240 may use data associated with a received query to determine the context, such as by determining the role of the user that submitted the query, an account of the cloud data platform 102 associated with the submitted query, a data share associated with the query, and the like. The constraint system 240 may provide data defining the determined context of the query to the other components of the constraint system 240, such as an enforcement determination component.

The constraint system 240 determines whether a join constraint should be enforced in relation to a received query. For example, the constraint system 240 uses the data received that indicates whether a join constraint is attached to any of the columns and/or the file defining the join constraints as well as the context of the query received from the constraint system 240 to determine whether a join constraint should be enforced. If a query constraint is not attached to any of the columns, the constraint system 240 determines that a join constraint should not be enforced in relation to the query. Alternatively, if a join constraint is attached to one of the columns, the constraint system 240 uses the context of the query to determine whether the join constraint should be enforced. For example, the constraint system 240 may use the context of the query to determine whether the conditions defined in the file attached to the column are satisfied to trigger the join constraint. In some embodiments, the constraint system 240 may use the context of the query as an input into the Boolean function defined by the join constraint to determine whether the join constraint is triggered. For example, if the Boolean function returns a true value, the constraint system 240 determines that the join constraint should be enforced. Alternatively, if the Boolean function returns a false value, the constraint system 240 determines that the join constraint should not be enforced. The constraint system 240 may provide data indicating whether the join constraint should be enforced to the other components of the constraint system 240, such as a join constraint enforcement component.

The constraint system 240 enforces a join constraint in relation to a query. For example, the constraint system 240 may prohibit an output to a query from including data values from any constrained columns of a shared dataset. This may include denying a query altogether based on the operations included in the query, such as if the query requests to simply output the values of a constrained column. However, the constraint system 240 may allow for many other operations to be performed while maintaining the confidentiality of the data values in the restricted columns, thereby allowing for additional functionality compared to current solutions (e.g., tokenization). For example, the constraint system 240 allows for operations that provide an output indicating a number of data values within a column that match a specified key value or values from another column, including fuzzy matches. As one example, two tables can be joined on a projection-constrained column or join-constrained table using a case-insensitive or approximate match. Tokenization solutions are generally not suitable for these purposes.

The constraint system 240 may also allow users to filter and perform other operations on data values stored in projection-constrained columns. For example, if an email-address column is projection-constrained or a table is join-constrained, an analyst end-user is prevented from enumerating all of the email addresses but can be allowed to count the number of rows for which the predicate “ENDSWITH (email, ‘database_123’)” is true. The constraint system 240 may provide an output to the query to a requesting user's client device.

FIG. 3 is a block diagram 300 illustrating components of the execution platform 110 of FIG. 3, in accordance with some embodiments of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 120-1 to 120-N shown in FIG. 3. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in cloud storage platform 104 of FIG. 1. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet, another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer useful.

In some embodiments, the virtual warehouses may operate on the same data in cloud storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

FIG. 4 is a flow diagram illustrating an example method for enforcing join constraints for query processing, according to some embodiments. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

The method 400 may be embodied in computer-readable instructions for execution by one or more hardware components (e.g., one or more processors) such that the operations of the method 400 may be performed by components of the data platform 102. Accordingly, the method 400 is described below, by way of example with reference thereto. However, it shall be appreciated that the method 400 may be deployed on various other hardware configurations and is not intended to be limited to deployment within the data platform 102.

At operation 402, the data platform 102 receives a first query directed towards a shared dataset in a data clean room, the first query including one or more functions. The data platform receives a request from a user or system. This request can be in the form of a SQL query, which is a standard language used to communicate with databases, or in a query template (as further described herein).

The query targets a dataset that is shared among multiple parties within the data clean room. This dataset can include sensitive information, and its access is governed by strict privacy and security policies. For example, a dataset is shared between two financial institutions for collaborative analysis without revealing individual customer details. The data platform 102 receives this SQL query as the initial step in the data processing workflow, where the data platform acknowledges and prepares to process the query.

To understand operation 402 in the context of the join constraint policy framework, the below description integrates the join constraint policy application into the process of receiving and handling the query.

The data platform incorporates a policy framework that enforces rules and constraints on how data can be accessed and manipulated within the data clean room. A specific type of policy within this framework as described in the embodiments herein is the join constraint policy. This policy restricts certain join operations on tables to protect sensitive information.

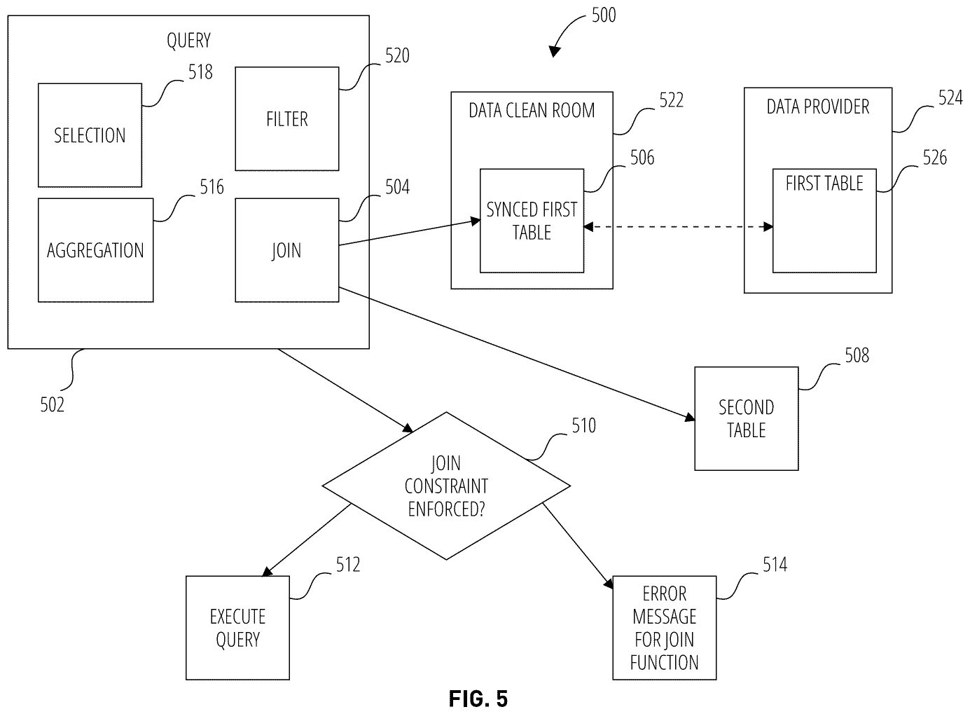

FIG. 5 is an architectural diagram 500 illustrating join constraint policy enforcement, according to some example embodiments. The query received by the data platform in FIG. 4 can be the query 502 of FIG. 5.

The policy framework in a data clean room is designed to ensure that data operations comply with privacy standards. This includes policies that govern how data can be accessed, manipulated, and shared.

The join constraint policy is a specific type of policy that restricts join operations such that join operations can be performed on certain datasets and not others. This policy helps protect sensitive information by controlling which datasets can be combined.

The data platform identifies the datasets that require join constraint policies or datasets that the customer has set join constraints on. These datasets can include sensitive or regulated information that the customer may not want to share with certain other customers.

The data platform creates join constraint policies specifying which join operations are allowed or disallowed (further described herein). For example, a policy might prohibit joining a customer data table with any other table containing financial information.

The join constraint policy is attached to the dataset or table. This process involves updating metadata or configurations to link the policy to the specific dataset. The join constraint policies are stored in a centralized policy management system. This system ensures that policies are consistently applied and updated as needed.

Each dataset's metadata or a separate portion of the dataset includes references to its associated join constraint policies. This metadata or separate portion is used during query processing to determine whether to enforce the policies and/or to use that data to apply the policies on queries.

The description below provides an example of setting up join constraint policies. Suppose there is a dataset named CustomerData that contains sensitive customer information. A join constraint policy is created to prevent CustomerData from being joined with datasets that contain personally identifiable information (PII). The join constraint policy is attached to the CustomerData dataset. The dataset's metadata is updated to include this policy.

Once the join constraint policy is attached to a dataset, any future queries that involve this dataset will be assessed against the policy. When a query is received that targets the dataset with the attached join constraint policy, the data platform parses the query to identify the operations involved, and the platform checks the query against the join constraint policy. If the query includes a prohibited join operation, the platform will either block the query or modify it to comply with the policy (as further described herein).

In summary, before any query is received, the join constraint policy framework involves identifying sensitive datasets, creating appropriate join constraint policies, and attaching these policies to the datasets. This setup ensures that any future queries on these datasets will be assessed against the join constraint policies, enforcing data security and privacy rules consistently.

As such, the data platform can apply the join constraint policy to a view or a table, where the table includes a first set of data. The applying of the join constraint to the table causes the join constraint to be enforced in response to any query that is executed against the table. The determining that the join constraint policy is to be enforced can include determining that the first query is to be executed on the table.

In summary, operation 402 involves the data platform 102 receiving a query directed at a shared dataset and applying the join constraint policy framework. The platform identifies the target table, checks for applicable join constraints, and enforces these constraints during query execution. This ensures that sensitive data is protected by preventing unauthorized or disallowed join operations, maintaining data privacy and security in the data clean room.

When the data platform receives a query, the data platform identifies which table and dataset the query is directed towards. This can involve a plurality of steps, such as parsing the query to determine the target of the SQL operations, finding object references, expanding views, and/or the like.

In some examples, a native application (app) is installed to manage data cleanroom operations, such as on the customer's side. The native app serves as the interface for adding data and policies.

The native app can be installed exclusively on the customer's infrastructure, where the provider side data is synchronized with the native app such that the customer can potentially have access to the data from the provider side. This ensures that data control remains within the provider's domain, enhancing security and compliance with data privacy regulations.

Providers can use the native app to add their datasets to the cleanroom environment. These datasets are essential for collaborative analytics and data processing. The native app facilitates seamless integration of various data sources, ensuring that the data is appropriately formatted and ready for cleanroom operations.

Customers and/or providers can define policies that govern how their data can be accessed and used. These policies include join constraints, access controls, and other privacy-preserving rules. Policies are attached directly to view or tables within the dataset. This attachment ensures that any operations on these tables adhere to the defined policies.

During installation, a link to a view is created. This view represents the dataset on the provider's side. When a query is made against this view, the native app ensures that all attached policies are enforced. This step guarantees that data operations comply with the customer's or provider's policies.

The actual query is executed on the customer's side using the native app. This setup allows customers to maintain control over their data while leveraging the provider's infrastructure. While the data physically resides on the provider's side, it is logically copied to the customer's side for query execution. This approach provides a balance between data locality and computational efficiency.

The same framework can be applied to local data that is not part of the data cleanroom. Customers can define and enforce policies on their local datasets using the native app. Whether the data is inside the DCR or local, the policies attached to tables ensure consistent enforcement of data governance rules.

The native app is installed on the customer's infrastructure. The app is configured to interface with the data cleanroom and manage datasets and policies. Providers use the app to upload and integrate their datasets into the cleanroom environment.

Returning to FIG. 4, at operation 404, the data platform 102 determines, from the context of the first query, that a join constraint policy is to be enforced in relation to the first query. In some examples, the determining that the join constraint policy is to be enforced is based on determining that the join constraint policy is attached to at least a portion of the first set of data of the shared dataset. In some examples, the join constraint policy restricts use of data values stored in the portion of the first set of data. The data platform checks if a join constraint policy is associated with the target table. This policy specifies whether certain join operations are allowed or disallowed for the table.

In the example of FIG. 5, the data platform determines if the join constraint is to be enforced. The data platform checks if a join constraint policy is associated with the target table. This policy plays a critical role in governing how data can be combined across different tables. The join constraint policy may specify various rules and conditions under which join operations are permitted. For instance, the join constraint may restrict joins to specific columns, limit the types of join functions that can be used, or completely disallow certain join operations. These policies are essential for maintaining data security and privacy, as they prevent unauthorized or unintended data linkages that could potentially expose sensitive information.

Returning to FIG. 4, at operation 406, the data platform 102 assesses the first query to identify that the one or more functions includes at least a join operation. The query contains specific SQL functions such as joins, aggregations, selections, and filters.

The data platform analyzes incoming queries directed at shared datasets within a data clean room. The goal is to ensure that any operations performed on the data comply with predefined policies, particularly join constraint policies. The data platform receives a query from a user or application. This query is intended to perform specific operations on a shared dataset. Typically, the query is written in SQL (Structured Query Language) and can include a variety of functions.

The data platform begins by parsing the query. This involves breaking down the query into its constituent parts to understand the operations it aims to perform. The data platform identifies the specific functions included in the query.

These functions could be joins, aggregations, selections, filters, etc. As shown in FIG. 5, the query 502 can include functions such as a join 504, a filter 520, a selection 518, an aggregation 516, and/or the like.

Among the various functions, the platform specifically looks for join operations. Joins are critical because they combine rows from two or more tables based on a related column, such as the synced first table 506 and the second table 508. Join operations can significantly impact data privacy and integrity, making it essential to apply any relevant join constraint policies.

By identifying join operations, the platform can enforce join constraint policies that may restrict how tables can be combined, ensuring that joins and other functions comply with policies helps maintain data privacy and security. Understanding the query's functions allows the platform to optimize query execution for better performance. Efficient assessment helps in managing computational resources effectively. Moreover, identifying and enforcing policies ensures that data operations comply with relevant regulations and governance standards. Detailed assessment provides audit trails for query operations, enhancing accountability.

In some examples, the join function includes an inner join function, which is an SQL operation used to combine rows from two or more tables based on a related column between them. An inner join returns only the rows where there is a match in both tables, effectively filtering out rows that do not have corresponding matches. This type of join is commonly used when the goal is to retrieve records that have related data in both tables, ensuring that the result set contains complete information from the joined tables.

For instance, there are two tables: one containing customer information and another containing order details. An inner join between these tables on a common column, such as CustomerID, would yield only the records where the CustomerID exists in both tables. This operation is crucial in data analysis and reporting within data clean rooms, as it ensures that only relevant and linked data is processed and exposed, thereby maintaining data integrity and relevance.

In some examples, the join constraint policy incorporates the concept of allowed join keys. This involves the data platform receiving specific join keys from the customer, which are designated as permissible for join operations. These allowed join keys define the columns or attributes in the dataset that are permitted to be used in join functions, thereby providing a controlled and secure way to link data between tables.

During the execution of the first query, the data platform assesses whether the join involves any of the allowed join keys specified by the customer. If the join keys used in the query match the allow join keys, the join operation proceeds as permitted. This mechanism ensures that only authorized columns are used in join operations, thereby enhancing data security and governance by preventing unauthorized or unintended data linkages.

In some examples, the data platform limits columns through allow join keys that provides customers with granular control over which columns in their dataset can be used in join operations. By specifying allow join keys, customers can dictate which individual columns are permissible for use in joins, thereby restricting access to sensitive or critical data fields. This ensures that only the necessary and authorized data is exposed during join operations, reducing the risk of unintended data disclosure.

When a query is executed, the data platform evaluates the join keys specified in the query against the predefined allow join keys. If the columns used in the join operation are included in the allow join keys, the join is allowed to proceed. This feature empowers customers to maintain tight control over their data, allowing them to protect sensitive information by limiting the scope of join operations to only the columns they have explicitly authorized. This level of control is crucial for maintaining data privacy and security in data clean rooms and other collaborative data environments.

In some examples, the data platform applies deny join keys that provides a layer of security and control for customers by allowing them to specify columns that should not be used in join operations. By defining deny join keys, customers can explicitly prevent certain sensitive or critical columns from being included in any join operations, regardless of other permissions or configurations. This helps safeguard confidential information and ensures that specific data fields remain protected from unintended exposure.

When a query is executed, the data platform checks the columns used in the join operation against the predefined deny join keys. If any column in the join operation matches a deny join key, the join is blocked, and the query fails to execute for that specific operation. This mechanism ensures that sensitive data remains inaccessible during join operations, providing a robust method for enforcing data privacy and security policies.

In some examples, the data platform enables both allow and deny join keys. By combining allow and deny join keys, customers can create a comprehensive and flexible data governance strategy, tailoring access controls to meet their specific privacy and security requirements.

Join constraints are an important aspect of data governance within data clean rooms, providing organizations with the ability to mandate or disallow specific joining operations on their tables. These constraints allow customers to exercise granular control over how different datasets are linked together, ensuring that only relevant data is combined. By limiting the columns or tables that can be used as join keys, join constraints help to prevent unintended data linkages that may expose sensitive information. This level of control is particularly important in environments where data privacy and security are paramount.

In some examples, the data platform enables mandatory join keys, where certain specified join keys must be included in any join operation involving the datasets they pertain to. When a query includes a join function, the data platform ensures that these mandatory join keys are part of the join condition. This requirement guarantees that joins are executed in a controlled and predictable manner, ensuring that essential linking columns are always used, thereby maintaining data integrity and security. By enforcing mandatory join keys, the platform ensures that joins adhere to predefined rules, enhancing the reliability and consistency of data linkages.

In addition to join constraints, aggregation and differential privacy policies play a significant role in data clean room use cases. These policies collectively ensure that data shared with external parties remains secure and confidential. Aggregation policies control how data is summarized or grouped, while differential privacy adds noise to the data to protect individual privacy. By enforcing these restrictions, organizations can share data more securely with external partners, enabling flexible access to shared data without compromising privacy. This framework ensures that data remains protected while still allowing for valuable insights and collaboration.

Returning to FIG. 4, at operation 408, the data platform 102 determines that the first query is configured to join a first set of data from the shared dataset (such as the synced first table 506) with a second set of data (such as the second table 508) using the join function.

The data platform parses the query to identify the presence of a join operation and understanding its specific type, in this case, an inner join. An inner join function is used to combine rows from two or more tables based on a related column between them, typically resulting in a dataset that includes only the rows with matching values in both tables. This operation is fundamental for merging datasets to derive meaningful insights, especially in data clean rooms where data from multiple sources is often combined.

The synced first table 506 can be accessed by the customer requesting the query within the data clean room 522. The data, which originates from the data provider, is made available to the customer within a secure and controlled environment known as the data clean room. The data clean room ensures that sensitive data is handled securely, allowing the customer to perform queries and analyses without directly exposing the underlying data.

The data platform enables the data provider 524 to make their data, such as the first table 526, available for access. The first table 526 is an example of a dataset that the data provider has shared for collaborative purposes. This table can contain various types of data relevant to the customer's needs, such as transaction records, user information, or other business metrics. This data can be provided in a way that maintains privacy and security, preventing unauthorized access and ensuring compliance with data governance policies.

Once the data provider makes the first table 526 available, the data platform syncs the data on the customer side via the data clean room. This synchronization process involves copying or mirroring the dataset from the provider's side to the customer's side within the secure environment of the data clean room. The synchronization ensures that the customer has access to the most up-to-date version of the dataset and policies, allowing them to run queries and perform analyses as if the data were locally available. The data clean room acts as an intermediary, maintaining the integrity and security of the data throughout this process.

The advantage of this setup is that it allows the customer to leverage the data provided by the data provider without compromising security or privacy. The data clean room 522 ensures that all interactions with the data are governed by strict policies and controls, preventing any unauthorized data access or leakage. This setup fosters a collaborative environment where data can be shared and utilized effectively while maintaining the highest standards of data protection. By syncing the first table 506 on the customer side, the data clean room enables seamless and secure data integration, supporting robust and compliant data analysis activities.

Returning to FIG. 4, at operation 410, the data platform 102 generates an output to the first query based on the execution of the one or more functions with the join constraint applied, the output to the first query not including data values stored in the portion of the first set of data based on determining that the join constraint policy is to be enforced in relation to the first query.

The join constraint policy is applied to the table such that any join operations specified in the query will be assessed to ensure they comply with the policy. For example, if the join constraint policy prohibits joining the table with another table that includes personally identifiable information (PII), the platform will check the query for such joins.

Once the join constraint policy is identified, the data platform assesses whether the first query complies with the specified policy by determining whether the join constraint is to be enforced 510. This involves checking if the columns used in the join are permitted according to the policy and if the type of join operation, such as the inner join, is allowed. If the query meets the policy requirements, the data platform proceeds to execute the join operation. Conversely, if the query violates the policy, the platform may block the operation or raise an error, ensuring that the constraints are enforced. This mechanism provides a robust framework for controlling data interactions, ensuring that only permissible data combinations occur.

The platform enforces the join constraint policy during query execution. If the query includes a prohibited join operation, the platform will block or modify the query to comply with the policy. The data platform then can generate an output by executing the query without data values that are prohibited.

In some examples, the output is without the prohibited data values and instead includes an indication of an error or failure to execute the first query when a join constraint policy is enforced on the first set of data. This occurs when the query attempts to perform a join operation that is not permitted by the established join constraints.

For example, if the join policy specifies that certain columns or datasets cannot be joined due to privacy or security concerns, the data platform will detect this violation and halt the execution of the query. The system then returns an error message or failure notification to the user, informing them that the query cannot be completed as requested. This mechanism ensures that data policies are strictly adhered to, preventing unauthorized or non-compliant data combinations. In the example of FIG. 5, the data platform outputs an error message 514 for the join message.

In some examples, the data platform can still execute the query despite some constraints. In this case, the output of the first query is based on the execution of the join function on the portion of the first set of data that is not restricted by the join constraint policy. Essentially, the data platform identifies the permissible subsets of data that can be joined according to the policy and proceeds with executing the join operation on these allowable data segments. This approach allows the query to return partial results based on the data that meets the policy requirements, providing the user with as much information as possible without violating any data constraints. This flexibility ensures that useful insights can still be derived from the data, even when certain join operations are restricted.

If the join constraint is not enforced, the data platform proceeds to execute the query (such as executing the query 512 in FIG. 5) as requested by the user. The data platform allows the join operations specified in the query to proceed without restrictions imposed by the join constraint policy. By not enforcing the join constraint, the platform ensures that all relevant data sets can be combined as required by the query, facilitating comprehensive data analysis and retrieval. This approach enables users to obtain complete results from their queries, leveraging the full potential of the available data without limitations imposed by privacy or security policies related to data linking and integration.

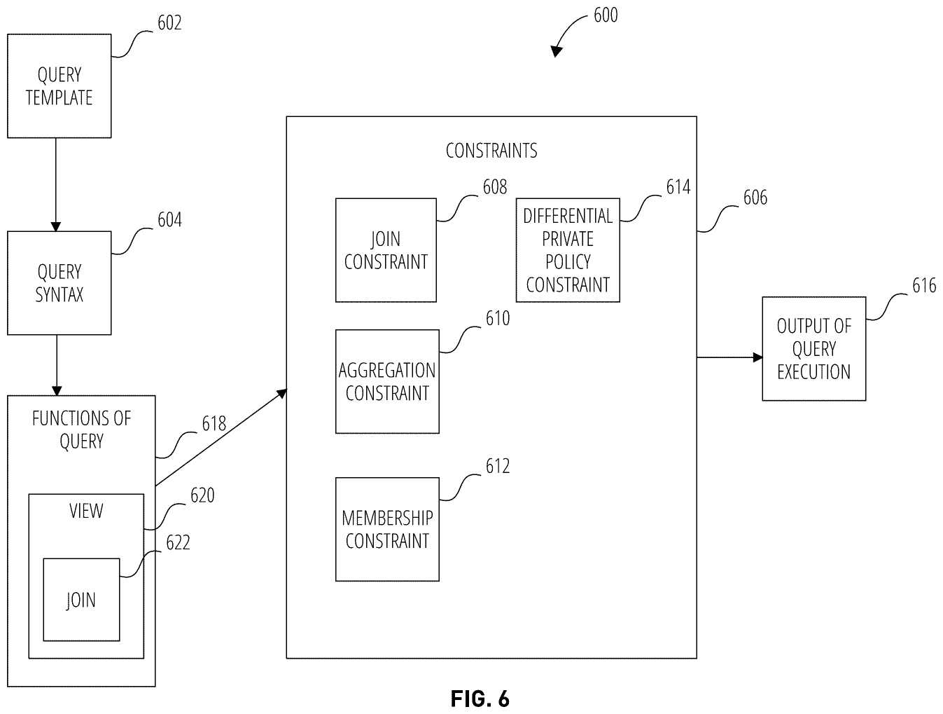

FIG. 6 illustrates an architectural diagram 600 illustrating executing of a query template based on a plurality of different constraint types, according to some example embodiments. The customer can provide a query request using a query template 602 with editable fields, which offers a streamlined and user-friendly way to interact with complex data systems. This template serves as a structured framework where specific fields are predefined but left open for user input.

By filling in these editable fields, the customer can tailor the query to their specific needs without needing extensive knowledge of the underlying SQL or data querying languages. This approach reduces the complexity of query formulation, making it accessible even to those who may not have advanced technical skills.

The template typically includes placeholders for key parameters such as table names, column names, filtering criteria, and join conditions. For example, a template might have a section for selecting the dataset, another for specifying the columns to retrieve, and fields for defining any filters or conditions to apply.

The customer can simply enter the relevant information into these fields, and the system will automatically generate the corresponding query based on the provided inputs. This method ensures that the query is syntactically correct and adheres to the platform's requirements, minimizing the chances of errors.

Additionally, using a template with editable fields can help enforce best practices and compliance with organizational policies. Since the template can be designed to include mandatory fields and predefined options, it ensures that all necessary parameters are specified and that the query adheres to any constraints or rules set by the organization. For instance, the template can be configured to automatically include certain security or privacy considerations, such as limiting access to sensitive columns or enforcing specific join constraints.

Overall, providing a query request through a template with editable fields enhances efficiency, accuracy, and security in data querying processes. It empowers customers to leverage the full capabilities of the data platform while maintaining control and oversight over how data is accessed and used. This approach simplifies the user experience, promotes consistency, and ensures that all queries are constructed in a way that aligns with organizational standards and policies.

The data platform converts the query template into query syntax 604, such as SQL, by taking the inputs provided by the customer in the editable fields and dynamically generating a complete, syntactically correct query.

The data platform substitutes the placeholder fields in the template with the actual values entered by the user. For instance, if a template includes placeholders for selecting specific columns, applying filters, or defining join conditions, the platform will replace these placeholders with the corresponding user inputs to construct a valid SQL query.

The conversion process ensures that the generated query adheres to the proper syntax and structure required by the SQL language or any other query language being used. This involves not only inserting the user-provided values but also ensuring that the overall query logic is maintained.

The data platform checks for common errors such as missing fields, incorrect data types, or invalid operations and makes necessary adjustments to produce a query that can be executed successfully against the database. This automated translation from a user-friendly template to a complex query syntax simplifies the process for users, enabling them to perform sophisticated data operations without needing deep technical expertise.

Once the query syntax is converted from a template or another format into a structured query language (SQL) or another executable syntax, the data platform assesses this syntax to identify the various functions the query is set to perform. This assessment involves parsing the query to understand its structure and the operations specified by different clauses within the query.

The data platform starts by breaking down the query into its fundamental components: SELECT, FROM, WHERE, JOIN, and other SQL clauses. Each of these components can contain specific functions that need to be executed to fulfill the query's purpose. For example, the SELECT clause defines the columns or expressions that need to be retrieved, while the FROM clause specifies the tables involved. The WHERE clause can contain conditions for filtering data, and the JOIN clause outlines how data from different tables should be combined based on related columns.

Among these functions, the data platform can identify complex operations such as view functions and join functions. A view function refers to the query creating or accessing a virtual table that represents a particular data subset.

This view is defined by an underlying query that can involve one or more tables and various operations like joins, aggregations, and filters. The data platform assesses how the view is constructed to understand the data relationships and any constraints that apply to these operations.

Join functions involve combining data from multiple tables, such as based on related columns. The data platform identifies the join functions within the query to determine how tables are linked and what data relationships are established, for ensuring that the join operations comply with any predefined join constraints or policies. Join constraints are rules that govern whether and how tables can be joined, often to protect sensitive data or maintain data integrity. The platform assesses the join functions to check if these constraints apply and, if so, enforces them to ensure compliance.

When a query includes a view function, the query is either creating or accessing a virtual table that represents a specific subset of data. A view function is different from a join function in that it defines a particular perspective or representation of the data, often using a SELECT statement to encapsulate a complex query into a single virtual table.

However, despite being conceptually different from a join function, a view function can still be subject to join constraint policies. This is because the view function might involve underlying operations that include joining multiple datasets. For instance, the view could be constructed from a query that selects and combines data from two or more tables based on related columns. In the example of FIG. 6, the query syntax is assessed to identify functions of the query 618, which include a view function 620. This view function requires that a join operation 622 be executed to generate the output data 616 for the view function. Therefore, even though the end-user might only see and interact with the view, the creation and maintenance of this view inherently involve join operations.

Given this relationship, the execution of a view function can trigger the application of join constraints. Join constraints are policies that govern whether and how tables can be joined, often designed to protect sensitive data and maintain data integrity. When a view function involves joining datasets, the data platform needs to assess whether these join operations comply with any predefined join constraints. This assessment ensures that the creation or querying of the view adheres to the same rules and restrictions as any direct join operation.

For example, if the join constraint policy restricts certain columns from being used as join keys, or disallows specific join operations to protect sensitive information, these constraints must also be enforced when the view is created or accessed. The data platform will parse the view definition, identify the join operations involved, and check if they meet the join constraints. If the constraints are violated, the platform might prevent the view from being created or accessed, or it might alter the view definition to comply with the constraints. This ensures that the data integrity and privacy policies are consistently applied, regardless of whether the data is accessed through direct queries or through views.

The join constraint policies can be applied to the protected dataset in any function that is referencing the protected dataset. For example, the query can include a store procedure, an external call that references the protected table, a query template, and/or the like that requires some form of referencing of the protected dataset, and thus, the data platform applies the join constraint on the query.

In a data platform, multiple policies can be applied to query requests and their execution to ensure data security, privacy, and proper usage. Examples of these constraint policies 606 include join constraints, aggregation constraints, and membership constraints, each serving distinct purposes to manage and control data access and manipulation.

Join constraints 608 are used to determine whether datasets can be joined together. These constraints are important in maintaining data privacy and integrity, as they govern which tables and columns can be combined in a query.

By enforcing join constraints, the data platform ensures that only permissible data relationships are established, preventing unauthorized or potentially sensitive data linkages. For example, a join constraint might disallow joins between specific tables to protect sensitive customer information or to comply with regulatory requirements. When a query is received, the platform checks the join constraints to determine if the requested join operation is allowed and if not, it will either modify the query or return an error.

Aggregation constraints 610 control the visibility of certain data through aggregation functions. Aggregation constraints enable the data platform to mask or restrict access to specific data points, ensuring that sensitive information is not exposed when data is aggregated. For example, a constraint might allow viewing only summary statistics such as averages or totals, but not the individual data entries that make up these aggregates.

This is particularly useful in scenarios where data needs to be shared with third parties or external stakeholders without revealing underlying detailed data. By applying aggregation constraints, the platform ensures that the results of the query are appropriately masked or summarized, maintaining the privacy and confidentiality of the individual data records.

For example, once a join constraint is applied, ensuring that only shared records are combined according to the specified policies, an aggregation constraint can further refine the data visibility. While the join constraint allows viewing of shared records, an aggregation constraint can restrict access to specific fields within those records, such as salary or email. This means that even if the joined data is permissible, certain sensitive fields can be masked or excluded based on the aggregation constraint.

In some examples, the data platform checks one or more of these constraints sequentially: it first applies the aggregation constraint, and if this constraint fails (e.g., a field is not allowed to be viewed), the system will not proceed to check other policies, thereby ensuring data privacy and compliance at multiple levels. In other examples, the data platform checks one or more of these constraints concurrently.

Membership constraints 612 restrict access to certain datasets based on the identity of the requesting party or customer. These constraints are designed to enforce data access policies at the user or organizational level, ensuring that only authorized users or groups can view or interact with specific datasets. For example, a membership constraint might prevent external contractors from accessing internal company data or restrict certain customer segments from viewing data related to other segments.

For example, once join constraints are applied to a query, the results of the join function can carry forward these constraints for subsequent operations. For example, if a second query includes another join function that aims to join the output of the first query with a third dataset, the data platform can first enforce the join constraint policy on this new join operation.

In some examples, after the join constraint is verified and applied, the platform then assesses and enforces membership constraints on the resulting dataset. This ensures that only authorized users can access the combined data, maintaining data governance and security throughout the query processing stages. Thus, the results of the join function not only adhere to the initial join constraints but also have membership restrictions attached to control access based on user permissions.

Differential privacy policy constraint 614 is designed to preserve privacy and restrict insights by controlling how specific columns in a dataset can be used which help to maintain data privacy and ensuring that sensitive information is not inadvertently exposed through queries. For example, a column usage constraint may prevent certain fields, like email or salary data, from being accessed or viewed in query results. When this constraint is enforced, any query attempting to access these restricted columns will either fail outright or return masked data, ensuring that sensitive information remains protected.

When a query is executed, the data platform verifies the membership constraints to ensure that the requesting party has the necessary permissions to access the requested data. If the requestor does not meet the membership criteria, the query will be denied or adjusted to comply with the access restrictions.

The differential privacy policy constraint 614 can include adding random noise to data, which helps mask the contributions of any particular group or individual without significantly altering overall statistics, thus preserving privacy while still allowing for meaningful data analysis.

The differential privacy policy constraint can include a privacy budget, which quantifies the amount of allowable privacy loss. Once this budget is exhausted, no further queries are permitted, adding another layer of privacy protection. Additionally, query restrictions can be enforced to limit the types of queries that can be executed, further safeguarding sensitive information.

Although examples described herein explain how a first type of constraint is applied before a second type of constraint, it is appreciated that the second type of constraint can be applied before the first type of constraint, and a combination of other types of constraints can be applied to the query request.

When a query is executed in a data platform, it can be run either on the provider's side to ensure that policies are applied correctly or on the customer's side, such as for local data. Each approach serves different purposes and comes with its own set of mechanisms to enforce data governance policies such as join constraints, aggregation constraints, and membership constraints.

In some examples, the assessing of the first query and the generating of the output to the first query is performed on a computing device that shared the shared dataset into the data clean room, such as a data provider. In provider-side execution, the query is processed on the data provider's infrastructure. This method ensures that the data provider's policies are strictly enforced before any data is shared with the customer.

When a query is received, the data platform on the provider's side first assesses the query to identify the functions involved, such as joins, aggregations, or views. The platform then checks these functions against the defined policies.

If the query includes a join operation, the data platform verifies whether the join is permitted based on the join constraints by checking if the datasets specified in the join are allowed to be combined. If the join is not permitted, the platform can either modify the query to exclude the join or return an error indicating that the join is not allowed.

For queries involving aggregation functions, the data platform applies aggregation constraints to ensure that sensitive data is appropriately masked or summarized, such as by only returning aggregated results without revealing underlying detailed data.

The data platform checks the identity of the requesting party against the membership constraints to ensure they have the necessary permissions to access the requested data. If the requester does not meet the criteria, the query is either denied or adjusted accordingly.

Once the policies are enforced, the data platform executes the query on the provider's data infrastructure. The results are then shared with the customer, ensuring that all policy constraints have been adhered to.

In some cases, the assessing of the first query and the generating of the output to the first query is performed on a computing device that generated the first query, such as by a customer. In customer-side execution, the query is processed on the customer's infrastructure, such as for local data. This method allows customers to manage and analyze their own data while still adhering to the data provider's policies.

The data platform provides query templates with editable fields that the customer can use to formulate their queries. These templates come with built-in policy enforcement mechanisms. When a query is created, the customer's local data platform assesses the query to identify functions like joins, aggregations, and views. The local platform then applies the same policies that the provider would enforce, ensuring consistent data governance.

For join operations, the local data platform checks the join constraints to determine if the specified joins are permitted. Similarly, for aggregation functions, the platform ensures that data is aggregated in accordance with the defined constraints. The local platform also enforces membership constraints by verifying that the user executing the query has the necessary permissions to access the data.

After applying all relevant policies, the local platform executes the query on the customer's data. The results are processed and presented to the user while ensuring that all policy constraints are respected.

In some scenarios, a hybrid approach is used where the query might be partially processed on the provider's side to enforce critical policies and then further processed on the customer's side for local data integration. This ensures a balance between strict policy enforcement and the flexibility of local data analysis.

By running queries on either the provider's side or the customer's side while ensuring that all relevant policies are applied, the data platform can maintain robust data governance, protecting sensitive information and complying with organizational and regulatory requirements.

In some cases, the join constraint policy can be enforced on other types of joins, such as inner joins, outer joins, disallowing join, and other types of joins described herein. Inner joins include only the data that is common to both tables being joined. For example, if a consumer requests data about users that must be linked to a dataset from the provider, an inner join will return only those users present in both datasets. This protects the provider's data by ensuring that only mutually existing records are exposed.

Outer joins can be left, right, or full outer joins. A left join (left outer join) returns all rows from the left table and the matched rows from the right table. If there is no match, the result is NULL from the right side. This type of join can be used to list all employees and their departments, including employees without any department assignments.

A right join (right outer join) is similar to left joins but returns all rows from the right table and the matched rows from the left table. A full outer join combines the results of both left and right outer joins, returning all rows when there is a match in one of the tables.

Natural joins automatically combine tables based on the equality of columns with the same names and data types in both tables. This join type simplifies queries by removing the need to specify the columns to join on explicitly. Join constraints can still be applied to ensure that only appropriate and non-sensitive data is combined.

Cross joins (or cartesian joins) combine each row of the first table with each row of the second table, resulting in M×N rows if the first table has M rows and the second table has N rows. Join constraints can be applied to limit the data being joined and protect sensitive information.

Explicit joins use explicit “ON” clauses to define join conditions, separating the logic of joining tables from the rest of the query. Implicit joins use “WHERE” clauses to define join conditions. Join constraints can be enforced more effectively on explicit joins as the conditions are clearly specified.

A query can contain a mix of inner and outer joins. In such cases, join constraints can be applied individually to each join operation to ensure that sensitive data is protected at every stage of the query execution. Three-way joins involve joining three tables. Join constraints can be applied to each join condition, ensuring that the combined data from the first join adheres to the constraints before being joined with the third table.

Join constraints can apply to a wide range of join types to ensure that only permissible data combinations are executed. This can involve blocking certain join types, limiting which columns can be used as join keys, and ensuring that sensitive data is not exposed through joins. By enforcing these constraints, data platforms can protect sensitive information while allowing consumers to perform meaningful analyses on shared datasets.

A policy and a constraint are both mechanisms used to govern how certain actions are performed. Although examples described herein describe certain features as a policy or a constraint (such as a join policy) for simplicity, it is appreciated that the features can apply to the other type (such as a join constraint) or a combination (such as a join constraint policy). For example, a policy can refer to a set of rules or guidelines that dictate how certain activities should be conducted, and/or provides a framework for decision-making and behavior within an organization or system. A constraint can refer to a specific restriction or limitation that must be adhered to within a system or process and/or defines what is not allowed or what must be maintained.

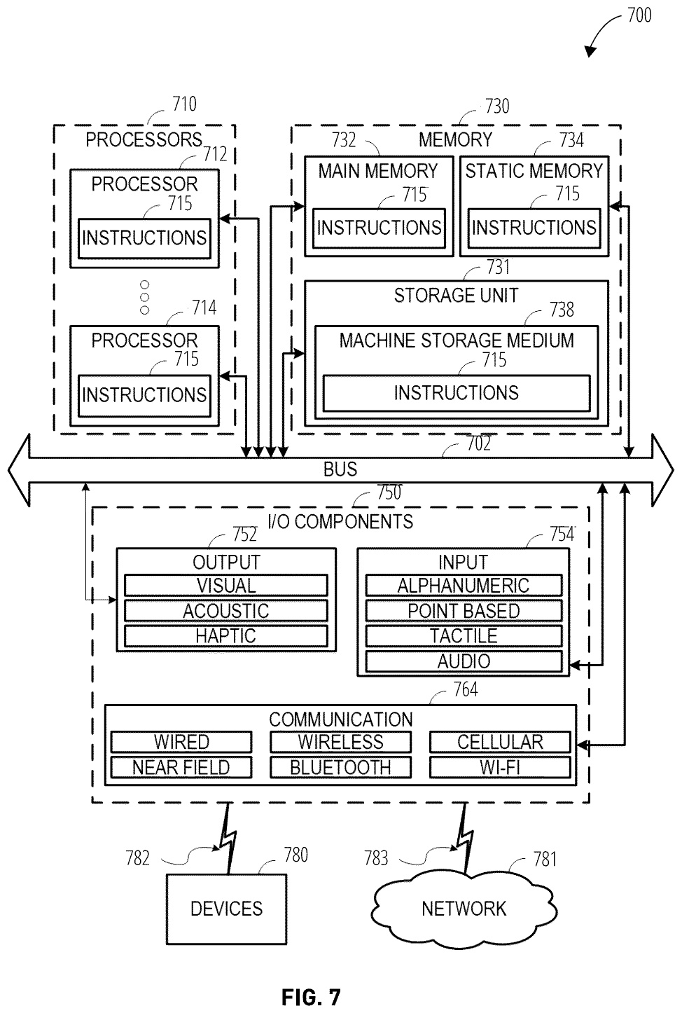

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 715 (e.g., software, a program, an application, an applet, an app, or other executable code), for causing the machine 700 to perform any one or more of the methodologies discussed herein, may be executed. For example, the instructions 715 may cause the machine 700 to implement portions of the data flows described herein. In this way, the instructions 715 transform a general, non-programmed machine into a particular machine 700 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 715, sequentially or otherwise, that specify actions to be taken by the machine 700. Further, while only a single machine 700 is illustrated, the term “machine” shall also be taken to include a collection of machines 700 that individually or jointly execute the instructions 715 to perform any one or more of the methodologies discussed herein.

The machine 700 includes processors 710 (such as processor 712 and processor 714), memory 730, and input/output (I/O) I/O components 750 (including output components 752 and input components 754) configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 715. The term “processor” is intended to include multi-core processors 710 that may comprise two or more independent processors (sometimes referred to as “cores”) that may execute instructions 715 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 730 may include a main memory 732, a static memory 734, and a storage unit 731, all accessible to the processors 710 such as via the bus 702. The main memory 732, the static memory 734, and the storage unit 731 comprise a machine storage medium 738 that may store the instructions 715 embodying any one or more of the methodologies or functions described herein. The instructions 715 may also reside, completely or partially, within the main memory 732, within the static memory 734, within the storage unit 731, within at least one of the processors 710 (e.g., within the processor's cache memory), or any suitable combination thereof, during execution thereof by the machine 700.

The I/O components 750 include components to receive input, provide output, produce output, transmit information, exchange information, capture measurements, and so on. The specific I/O components 750 that are included in a particular machine 700 will depend on the type of machine. For example, portable machines, such as mobile phones, will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 750 may include communication components 764 operable to couple the machine to a network 781 via a coupler 783 or to devices 780 via a coupling 782. For example, the communication components 764 may include a network interface component or another suitable device to interface with the network 781. In further examples, the communication components 764 may include wired communication components, wireless communication components, cellular communication components, and other communication components to provide communication via other modalities. The devices 780 may be another machine or any of a wide variety of peripheral devices (e.g., a peripheral device coupled via a universal serial bus (USB)). For example, as noted above, the machine 700 may correspond to any one of the client device 112, the compute service manager 108, and the execution platform 110, and may include any other of these systems and devices.

The various memories (e.g., 730, 732, 734, and/or memory of the processor(s) 710 and/or the storage unit 731) may store one or more sets of instructions 715 and data structures (e.g., software), embodying or utilized by any one or more of the methodologies or functions described herein. These instructions 715, when executed by the processor(s) 710, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 781 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 781 or a portion of the network 781 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 715 may be transmitted or received over the network 781 using a transmission medium via a network interface device (e.g., a network interface component included in the communication components 764) and utilizing any one of a number of well-known transfer protocols (e.g., hypertext transfer protocol (HTTP)). Similarly, the instructions 715 may be transmitted or received using a transmission medium via the coupling 782 (e.g., a peer-to-peer coupling) to the devices 780. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 715 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a computer system comprising: at least one hardware processor; and one or more computer storage media containing instructions that, when executed by the at least one hardware processor, cause the computer system to perform operations comprising: receiving a first query directed towards a shared dataset in a data clean room, the first query comprising one or more functions; assessing the first query to identify that the one or more functions comprises at least a join function, the join function being an inner join function; determining that the first query is configured to join a first set of data from the shared dataset with a second set of data using the inner join function; determining that a join constraint policy is to be enforced in relation to the first query based on determining that the join constraint policy is attached to at least a portion of the first set of data of the shared dataset, the join constraint policy restricting use of data values stored in the portion of the first set of data; and generating an output to the first query based on the execution of the one or more functions, the output to the first query without data values stored in the portion of the first set of data based on determining that the join constraint policy is to be enforced in relation to the first query.

In Example 2, the subject matter of Example 1 includes, wherein the operations further comprise applying the join constraint policy to a table, the table comprising the first set of data, wherein applying the join constraint policy to the table causes the join constraint policy to be enforced in response to any query that is executed against the table, wherein determining that the join constraint policy is to be enforced comprises determining that the first query is to be executed on the table.

In Example 3, the subject matter of Examples 1-2 includes, wherein the operations further comprise providing a native application to a customer computing device, the native application configured to create the data clean room, and attach the join constraint policy onto the shared dataset such that query functions executed on the shared dataset require the assessment of the join constraint policy to determine whether the join constraint policy is to be enforced.

In Example 4, the subject matter of Examples 1-3 includes, wherein the operations further comprise receiving allow join keys from a customer computing device, and applying the allow join keys to the join constraints, the execution of the first query comprising checking whether the first data set is included in the allow join keys.

In Example 5, the subject matter of Example 4 includes, wherein the allow join keys enable the customer computing device to control the execution of queries on individual columns within the first set of data.

In Example 6, the subject matter of Examples 1-5 includes, wherein the operations further comprise receiving deny join keys from a customer computing device, and applying the deny join keys to the join constraints, the execution of the first query comprising checking whether the first data set is not included in the deny join keys.

In Example 7, the subject matter of Examples 1-6 includes, wherein the output to the first query comprises an indication of an error or failure to execute the query based on the join constraint policy being enforced on the first set of data.

In Example 8, the subject matter of Examples 1-7 includes, wherein the output to the first query is based on an execution of the join function on data in the first set of data that does not have the join constraint policy being enforced.

In Example 9, the subject matter of Examples 1-8 includes, wherein receiving the first query comprises receiving a query template with editable fields filled by a customer computing device, the operations further comprising converting the query template into query syntax, assessing the first query comprising assessing the query syntax.

In Example 10, the subject matter of Examples 1-9 includes, wherein the first query comprises a request for a particular view, the view requiring the execution of the join function to generate a dataset for the particular view, the assessing of the first query comprising identifying that the first query comprises the request for the particular view, further assessing the request for the particular view to determine that the particular view requires the execution of the join function.

In Example 11, the subject matter of Example 10 includes, wherein the assessing of the first query and the generating of the output to the first query is performed on a computing device that generated the first query.

In Example 12, the subject matter of Examples 10-11 includes, wherein the assessing of the first query and the generating of the output to the first query is performed on a computing device that shared the shared dataset into the data clean room.

In Example 13, the subject matter of Examples 1-12 includes, wherein the operations further comprise receiving a second query that comprises another join function configured to join the output of the first query with a third set of data; and enforcing a membership constraint policy on the other join function based on the join constraint policy being included in the output of the first query.

In Example 14, the subject matter of Examples 1-13 includes, wherein the operations further comprise adding the join constraint policy to the output of the first query; receiving a second query that s another join function configured to join the output of the first query with a third set of data; and enforcing the join constraint policy on the other join function based on the join constraint policy being included in the output of the first query.

In Example 15, the subject matter of Examples 1-14 includes, wherein the operations further comprise, prior to generating the output to the first query, determining whether another constraint type other than the join constraint policy is to be enforced in relation to the first query, and generating the output based on the determination on whether the other constraint type is to be enforced.

In Example 16, the subject matter of Example 15 includes, wherein the other constraint type s an aggregation constraint, a membership constraint, or a differential private policy constraint.

In Example 17, the subject matter of Examples 1-16 includes, wherein the first query s a mix of a plurality of different types of joins, the operations further comprise determining whether the join constraint policy applies to each join operation of the plurality of different types of joins.

Example 18 is a method performed by at least one hardware processor, the method comprising: receiving a first query directed towards a shared dataset in a data clean room, the first query comprising one or more functions; assessing the first query to identify that the one or more functions s at least a join function, the join function being an inner join function; determining that the first query is configured to join a first set of data from the shared dataset with a second set of data using the inner join function; determining that a join constraint policy is to be enforced in relation to the first query, the determining that the join constraint policy is to be enforced is based on determining that the join constraint policy is attached to at least a portion of the first set of data of the shared dataset, the join constraint policy restricting use of data values stored in the portion of the first set of data; and generating an output to the first query based on the execution of the one or more functions, the output to the first query without data values stored in the portion of the first set of data based on determining that the join constraint policy is to be enforced in relation to the first query.

In Example 19, the subject matter of Example 18 includes, wherein the method further comprises applying the join constraint policy to a table, the table comprising the first set of data, wherein applying the join constraint policy to the table causes the join constraint policy to be enforced in response to any query that is executed against the table, wherein determining that the join constraint policy is to be enforced comprises determining that the first query is to be executed on the table.

Example 20 is one or more machine-storage media containing instructions that, when executed by at least one hardware processor of a computer system, cause the computer system to perform operations comprising: receiving a first query directed towards a shared dataset in a data clean room, the first query comprising one or more functions; assessing the first query to identify that the one or more functions s at least a join function, the join function being an inner join function; determining that the first query is configured to join a first set of data from the shared dataset with a second set of data using the inner join function; determining that a join constraint policy is to be enforced in relation to the first query, the determining that the join constraint policy is to be enforced is based on determining that the join constraint policy is attached to at least a portion of the first set of data of the shared dataset, the join constraint policy restricting use of data values stored in the portion of the first set of data; and generating an output to the first query based on the execution of the one or more functions, the output to the first query without data values stored in the portion of the first set of data based on determining that the join constraint policy is to be enforced in relation to the first query.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

1. A computer system comprising:
at least one hardware processor; and
one or more computer-storage media containing instructions that, when executed by the at least one hardware processor, cause the computer system to perform operations comprising:
receiving a first query directed towards a shared dataset in a data clean room, the first query comprising one or more functions;
assessing the first query to identify that the one or more functions comprises at least a join function;
determining that the first query is configured to join a first set of data from the shared dataset with a second set of data using the join function;
determining that a join constraint policy is to be enforced in relation to the first query based on determining that the join constraint policy is attached to at least a portion of the first set of data of the shared dataset, the join constraint policy restricting use of data values stored in the portion of the first set of data, the determining that the join constraint policy is to be enforced comprises at least validating that each column designated as a join key in the join operation complies with column-level restrictions defined by the join constraint policy; and
generating an output to the first query based on the execution of the one or more functions, the output to the first query without data values stored in the portion of the first set of data based on determining that the join constraint policy is to be enforced in relation to the first query.

2. The computer system of claim 1, wherein the operations further comprise applying the join constraint policy to a table, the table comprising the first set of data, wherein applying the join constraint policy to the table causes the join constraint policy to be enforced in response to any query that is executed against the table, wherein determining that the join constraint policy is to be enforced comprises determining that the first query is to be executed on the table.

3. The computer system of claim 1, wherein the operations further comprise providing a native application to a customer computing device, the native application configured to create the data clean room, and attach the join constraint policy onto the shared dataset such that query functions executed on the shared dataset require the assessment of the join constraint policy to determine whether the join constraint policy is to be enforced.

4. The computer system of claim 1, wherein the operations further comprise receiving allow join keys from a customer computing device, and applying the allow join keys to the join constraints, the execution of the first query comprising checking whether the first data set is included in the allow join keys.

5. The computer system of claim 4, wherein the allow join keys enable the customer computing device to control the execution of queries on individual columns within the first set of data.

6. The computer system of claim 1, wherein the operations further comprise receiving deny join keys from a customer computing device, and applying the deny join keys to the join constraints, the execution of the first query comprising checking whether the first data set is not included in the deny join keys.

7. The computer system of claim 1, wherein the output to the first query comprises an indication of an error or failure to execute the query based on the join constraint policy being enforced on the first set of data.

8. The computer system of claim 1, wherein the output to the first query is based on an execution of the join function on data in the first set of data that does not have the join constraint policy being enforced.

9. The computer system of claim 1, wherein receiving the first query comprises receiving a query template with editable fields filled by a customer computing device, the operations further comprising converting the query template into query syntax, assessing the first query comprising assessing the query syntax.

10. The computer system of claim 1, wherein the first query comprises a request for a particular view, the view requiring the execution of the join function to generate a dataset for the particular view, the assessing of the first query comprising identifying that the first query comprises the request for the particular view, further assessing the request for the particular view to determine that the particular view requires the execution of the join function.

11. The computer system of claim 10, wherein the assessing of the first query and the generating of the output to the first query is performed on a computing device that generated the first query.

12. The computer system of claim 10, wherein the assessing of the first query and the generating of the output to the first query is performed on a computing device that shared the shared dataset into the data clean room.

13. The computer system of claim 1, wherein the operations further comprise receiving a second query that comprises another join function configured to join the output of the first query with a third set of data; and enforcing a membership constraint policy on the other join function based on the join constraint policy being included in the output of the first query.

14. The computer system of claim 1, wherein the operations further comprise adding the join constraint policy to the output of the first query; receiving a second query that comprises another join function configured to join the output of the first query with a third set of data; and enforcing the join constraint policy on the other join function based on the join constraint policy being included in the output of the first query.

15. The computer system of claim 1, wherein the operations further comprise, prior to generating the output to the first query, determining whether another constraint type other than the join constraint policy is to be enforced in relation to the first query, and generating the output based on the determination on whether the other constraint type is to be enforced.

16. The computer system of claim 15, wherein the other constraint type an aggregation constraint, a membership constraint, or a differential private policy constraint.

17. The computer system of claim 1, wherein the first query comprises a mix of a plurality of different types of joins, the operations further comprise determining whether the join constraint policy applies to each join operation of the plurality of different types of joins.

18. A method performed by at least one hardware processor, the method comprising:
receiving a first query directed towards a shared dataset in a data clean room, the first query comprising one or more functions;
assessing the first query to identify that the one or more functions comprises at least a join function;
determining that the first query is configured to join a first set of data from the shared dataset with a second set of data using the join function;
determining that a join constraint policy is to be enforced in relation to the first query, the determining that the join constraint policy is to be enforced is based on determining that the join constraint policy is attached to at least a portion of the first set of data of the shared dataset, the join constraint policy restricting use of data values stored in the portion of the first set of data, the determining that the join constraint policy is to be enforced comprises at least validating that each column designated as a join key in the join operation complies with column-level restrictions defined by the join constraint policy; and
generating an output to the first query based on the execution of the one or more functions, the output to the first query without data values stored in the portion of the first set of data based on determining that the join constraint policy is to be enforced in relation to the first query.

19. The method of claim 18, wherein the method further comprises applying the join constraint policy to a table, the table comprising the first set of data, wherein applying the join constraint policy to the table causes the join constraint policy to be enforced in response to any query that is executed against the table, wherein determining that the join constraint policy is to be enforced comprises determining that the first query is to be executed on the table.

20. One or more machine-storage media containing instructions that, when executed by at least one hardware processor of a computer system, cause the computer system to perform operations comprising:
receiving a first query directed towards a shared dataset in a data clean room, the first query comprising one or more functions;
assessing the first query to identify that the one or more functions comprises at least a join function, the join function being a join function;
determining that the first query is configured to join a first set of data from the shared dataset with a second set of data using the join function;
determining that a join constraint policy is to be enforced in relation to the first query, the determining that the join constraint policy is to be enforced is based on determining that the join constraint policy is attached to at least a portion of the first set of data of the shared dataset, the join constraint policy restricting use of data values stored in the portion of the first set of data, the determining that the join constraint policy is to be enforced comprises at least validating that each column designated as a join key in the join operation complies with column-level restrictions defined by the join constraint policy; and
generating an output to the first query based on the execution of the one or more functions, the output to the first query without data values stored in the portion of the first set of data based on determining that the join constraint policy is to be enforced in relation to the first query.
